(19) United States
(12) Patent Application Publication
(10) Pub. No.: US 2026/0002413 A1
(43) Pub. Date: Jan. 1, 2026

(54) TOOL TRAY.

(71) Applicant: Frédéric Boucher, Mont Saint-Hilaire (CA)

(72) Inventor: Frédéric Boucher, Mont Saint-Hilaire (CA)

(21) Appl. No.: 19/249,723

(22) Filed: Jun. 25, 2025

(30) Foreign Application Priority Data
Jun. 28, 2024 (GB) 2409440.1

(51) Int. Cl. E06C 7/14; B25H 3/06; E04G 5/00

(52) U.S. Cl. CPC E06C 7/14; B25H 3/06; E04G 5/003

(57) ABSTRACT

A tool tray configured for engaging either a step of a stepladder or a guardrail of a scaffold or a nacelle. The tool tray defines a step receiving recess opening downwardly and configured for receiving the step and a pair of guardrail engaging hooks opening downwardly, protruding laterally outwardly relative to the tray and configured for engaging the guardrail. A resiliently deformable step engaging hook is provided between the guardrail engaging hooks.

### FIELD OF THE INVENTION

The present invention relates to the general field of construction equipment, and, more particularly, to a tool tray.

### BACKGROUND

Tool trays may be used by a user standing on a particular elevated support, such as a stepladder, a scaffold or a power actuated nacelle, among others. Such tool trays are typically provided with attachments usable for stably securing the tool tray along a top portion of a specific one of these elevated support during construction, renovation and/or maintenance work on a worksite. For practical use, or simply for time saving purposes, it is often required to have more than one type of elevated support, such as a stepladder, a scaffold and/or a power actuated nacelle, to be simultaneously present on a given work site. Thus, a worker may stand alternatively on two or more of these different supports to complete a task more rapidly. However, the tool trays on the market are typically configured for removable attachment only one specific type of elevated support. Thus the worker is forced to manually transport the necessary tools and parts from one type of elevated support to a different one at another location requiring about the same tools and parts. This recurrent manual transport of tools and parts can quickly become tiresome and time consuming, especially if the tools and parts are particularly heavy.

Another problem resides in the fact that sometimes, only a portion of the tools and parts required at one location, needs to be transported at another location. In these situation, workers may often chose to detach one tool tray from an elevated support means, and simply lay it on top of the tool tray attached to the support means at the next work location. These pile ups of incompatible tool trays between different types of elevated support means may provoke work accidents.

Thus, there is a need on the market for an improved tool tray that avoids the aforementioned disadvantages.

In a broad aspect, the present invention provides such an improved tool tray, and a method of using same.

### SUMMARY OF THE INVENTION

In a broad aspect, there is provided a tool tray securable to a step of stepladders and a guardrail of scaffolds and nacelles, the tool tray comprising: a tray bottom wall defining a bottom wall recess extending laterally inwardly thereinto; a tray peripheral wall extending upwardly from the tray bottom wall; a recess top wall extending from the tray peripheral wall above the bottom wall recess, the tray peripheral wall and the recess top wall together defining a step receiving recess opening downwardly and configured for receiving the step; a step engaging hook extending downwardly from the recess top wall and configured for engaging the step when the step is received in the step receiving recess; and a pair of guardrail engaging hooks opening downwardly, protruding laterally outwardly relative to the tray peripheral wall and configured for engaging the guardrail, the step engaging hook being provided between the guardrail engaging hooks; the step engaging hook being resiliently deformable between an unbiased configuration and a biased configuration, wherein, in the unbiased configuration, the step engaging hook protrudes laterally relative to the tray peripheral wall, and, in the biased configuration, the step engaging hook is moved inwardly towards the step receiving recess relative to the unbiased configuration.

There may also be provided a tool tray wherein the step engaging hook defines a hook distal end opposed to the recess top wall, the step engaging hook being length adjustable to selectively vary a distance between the recess top wall and the hook distal end.

There may also be provided a tool tray wherein the step engaging hook defines a spacing segment extending from the recess top wall, an intermediate segment extending from the spacing segment at the hook distal end and an end segment extending from the intermediate segment opposed to the spacing segment, the spacing, intermediate and end segments together having a generally J-shaped configuration.

There may also be provided a tool tray further comprising an accessory removably mounted to the tray peripheral wall, wherein the accessory and the tray peripheral wall are mounted to each other through a key-and-keyhole arrangement including a key and a keyhole, wherein the key is rotatable between an unlocked orientation in which the key is movable through the keyhole and a locked orientation in which the key is prevented from moving through the keyhole through mechanical interference between the key and the tray peripheral wall.

There may also be provided a tool tray wherein the keyhole includes a tray keyhole extending through the tray peripheral wall and wherein the accessory includes an accessory body and the key extending from the accessory body.

There may also be provided a tool tray wherein the accessory includes a plate positionable parallel to a portion of the tray peripheral wall, the plate and tray peripheral wall each defining a respective keyhole configured and positioned so that the keyholes of the plate and tray peripheral wall are in register with each other when the tool tray and accessory are secured to each other, the key being inserted through both the keyholes of the plate and tray peripheral wall when the tray and the accessory are mounted to each other.

There may also be provided a tool tray wherein the plate is peripheral to an accessory recess opening downwardly and configured for receiving thereinto the guardrail receiving hooks with the plate and tray peripheral wall adjacent and parallel to each other.

There may also be provided a tool tray wherein the peripheral wall defines a corner at one end of the portion of the tray peripheral wall and the plate includes at least one slit for receiving the tray peripheral wall thereinto at the corner when the guardrail receiving hooks are received in the accessory recess.

There may also be provided a tool tray wherein the accessory is an other tray.

There may also be provided a tool tray wherein the other tray is triangular and defines perpendicularly extending other tray guardrail engaging hooks opening downwardly and configured for engaging the guardrail at a corner thereof.

There may also be provided a tool tray wherein the accessory is a tool holder.

There may also be provided a tool tray wherein the accessory is a drawer.

There may also be provided a tool tray wherein the key includes a key first end portion insertable through the keyhole, a key second end portion that is larger than the keyed aperture and a key spacing portion extending between the key first and second end portions so that the key first and second end portions and the key spacing portion extend along a key longitudinal axis, the key spacing portion being also insertable in the keyhole, the key first and second end portions both protruding laterally relative to the key spacing portion.

There may also be provided a tool tray wherein the key is configured so that when the key first end portion is inserted through the keyhole and pushed therethrough to position the key spacing portion in the keyhole, rotating the key results in the key becoming locked to the keyhole due to the key first and second end portions both protruding laterally relative to the keyhole.

There may also be provided a tool tray wherein the key second end portion is shaped to act as a handle.

Advantageously, using the proposed tool tray, the user may avoid having to manually transfer the tools and parts from one tool tray to another on their respective type of support, and thus save time, by simply removing one tool tray from its support, and mounting the latter to a different type of support. The resilient hook can facilitate this, as it may frictionally engage the guardrail, thereby improving the solidity of the connection between the tool tray and the guardrail. Also, in some embodiments, when only some tools or similar elements need to be moved, one may move only the accessory from one tray to the other.

The contents of the priority document, UK patent application GB 2409440.1 filed Jun. 28, 2024 is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a front perspective view, illustrates an embodiment of a tool tray, according to the present invention, configured for engagement with a top portion of a stepladder;

FIG. 2, in a rear perspective view, illustrates the tool tray in FIG. 1;

FIG. 3, in a top plan view, illustrates the tool tray in FIG. 1;

FIG. 4, in a rear elevational view, illustrates the tool tray in FIG. 1;

FIG. 5, in a side cut away view relative to section line V-V in FIG. 3, illustrates the tool tray in FIG. 1;

FIG. 6, in a rear elevational view, illustrates the tool tray in FIG. 1, including an adjustable hook-shaped plate member;

FIG. 7, in a rear perspective view, illustrates a tool tray similar to the tool tray in FIG. 1, here shown mounted on the top step of a stepladder;

FIG. 8, in another rear perspective view, illustrates the tool tray in FIG. 7;

FIG. 9, in a schematic partial view, illustrates a key engagement movement relative to a keyhole defined in a tray peripheral wall;

FIGS. 10, in a front perspective view, illustrates an example of an accessory mountable to the tool tray of FIG. 7;

FIGS. 11, in a front perspective view, illustrates another example of an accessory mountable to the tool tray of FIG. 7;

FIGS. 12, in a front perspective view, illustrates yet another example of an accessory mountable to the tool tray of FIG. 7;

FIGS. 13, in a front perspective view, illustrates yet another example of an accessory mountable to the tool tray of FIG. 7;

FIGS. 14, in a front perspective view, illustrates yet another example of an accessory mountable to the tool tray of FIG. 7;

FIGS. 15, in a front perspective view, illustrates yet another example of an accessory mountable to the tool tray of FIG. 7;

FIGS. 16, in a front perspective view, illustrates yet another example of an accessory mountable to the tool tray of FIG. 7;

FIG. 17, in a perspective view, illustrates another embodiment of a tool tray, according to the present invention;

FIG. 18, in an alternative perspective view, illustrates the tool tray in FIG. 17;

FIG. 19, in a front perspective view, illustrates the tool tray in FIGS. 17 and 18, here shown engaged on adjacent portions of two railing members part of a guardrail near a perpendicular junction thereof;

FIG. 20, in a front perspective view, illustrates the tool tray in FIG. 19, here shown having another tool tray of the invention removably connected along a rectilinear wall segment thereof;

FIG. 21, in a front perspective view, illustrates the tool tray in FIGS. 17 and 18, here shown removably connected along a rectilinear wall segment of another tool tray of the invention mounted to a top step of a stepladder;

FIG. 22, in a perspective view, illustrates yet another embodiment of a tool tray, according to the present invention;

FIG. 23, in an alternative perspective view, illustrates the tool tray in FIG. 22;

FIG. 24, in a side perspective view, illustrate the tool tray in FIG. 22, here shown in a telescopically extended position;

FIG. 25, in a side elevational view, illustrates the tool tray in FIG. 22;

FIG. 26, in a longitudinal end elevational view, illustrate the tool tray in FIG. 22;

FIG. 27, in a top perspective view, illustrates the tool tray in FIG. 22, here shown engaged on a pair of parallelly spaced apart railing members of a guardrail of a scaffold or power actuated nacelle;

FIG. 28, in a top perspective view, illustrates the tool tray in FIG. 22, here shown removably connected along a rectilinear wall segment of another tool tray of the invention;

FIG. 29, in a perspective view, illustrates yet another embodiment of a tool tray, according to the present invention;

FIG. 30, in an alternative perspective view, illustrates the tool tray in FIG. 29;

FIG. 31, in a perspective view, illustrates yet another embodiment of a tool tray, according to the present invention;

FIG. 32, in an alternative perspective view, illustrates the tool tray in FIG. 31;

FIG. 33, in a perspective view, illustrates yet another embodiment of a tool tray, according to the present invention;

FIGS. 34, in a rear perspective view, illustrates the tool tray in FIGS. 29 and 30, here shown engaged on the top step of a stepladder, and to which is connected, the tool tray in FIGS. 31 and 32;

FIGS. 35, in a rear perspective view, illustrates the tool tray in FIGS. 29 and 30, here shown engaged on the top step of a stepladder, and to which is connected, the tool tray in FIG. 33;

FIG. 36, in a rear perspective view, illustrates the tool tray in FIGS. 29 and 30, here showing the two steps method of engaging the tool tray on two perpendicular railing members;

FIG. 37, in side elevational cross-section view, illustrates the tool tray in FIGS. 29 and 30, on which is engaged in a lowered down movement, the tool tray illustrated in FIG. 33;

FIG. 38, in a front perspective view, illustrates a key provided with a handle, and usable for removably mounting two tool trays to each other;

FIG. 39, in a rear perspective view, illustrates the key of FIG. 38;

FIG. 40, in a front elevational view, illustrates the key of FIG. 38;

FIG. 41, in a rear elevational view, illustrates the key of FIG. 40; and

FIG. 42, in a perspective view, illustrates the deformation of the step engaging hook when the tool tray in FIGS. 29 and 30 is engaged on two perpendicular railing members.

### DETAILED DESCRIPTION

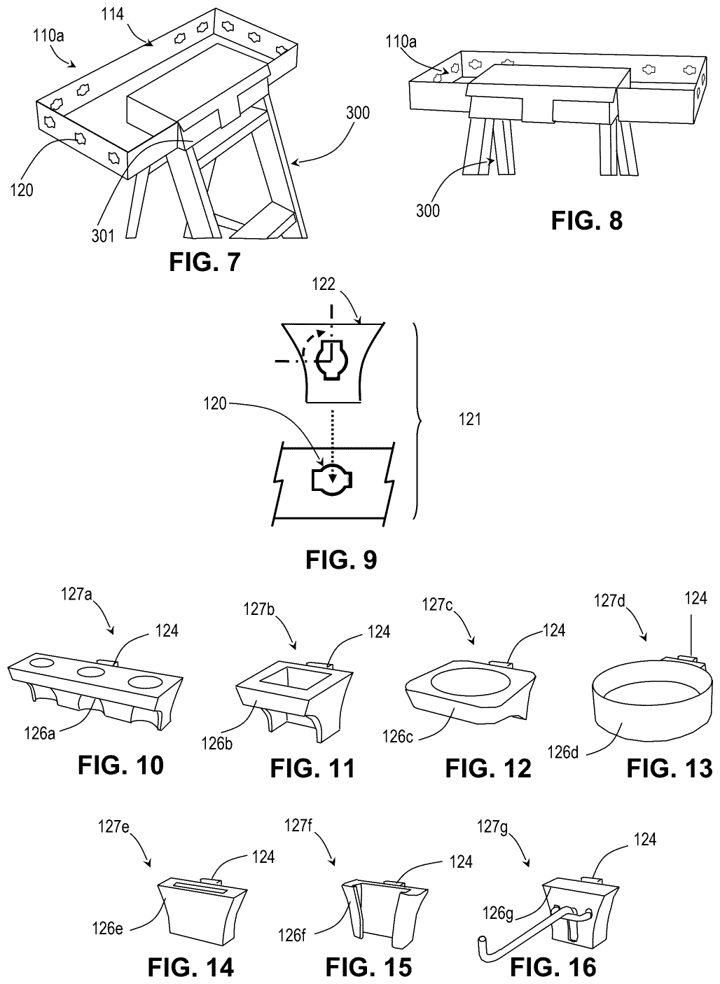

The present invention is for a tool tray, which is part, in some embodiments, of an interlocking modular tool tray system usable for user selectively and safely supporting hand tools and parts on a step of stepladder, a guardrail of a scaffold, or a guardrail of apower actuated nacelle, as exemplified for example, in FIGS. 7, 19 and 27.

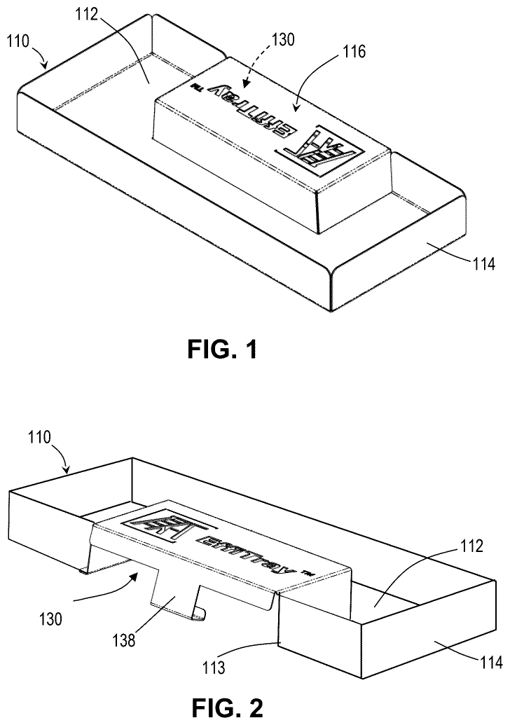

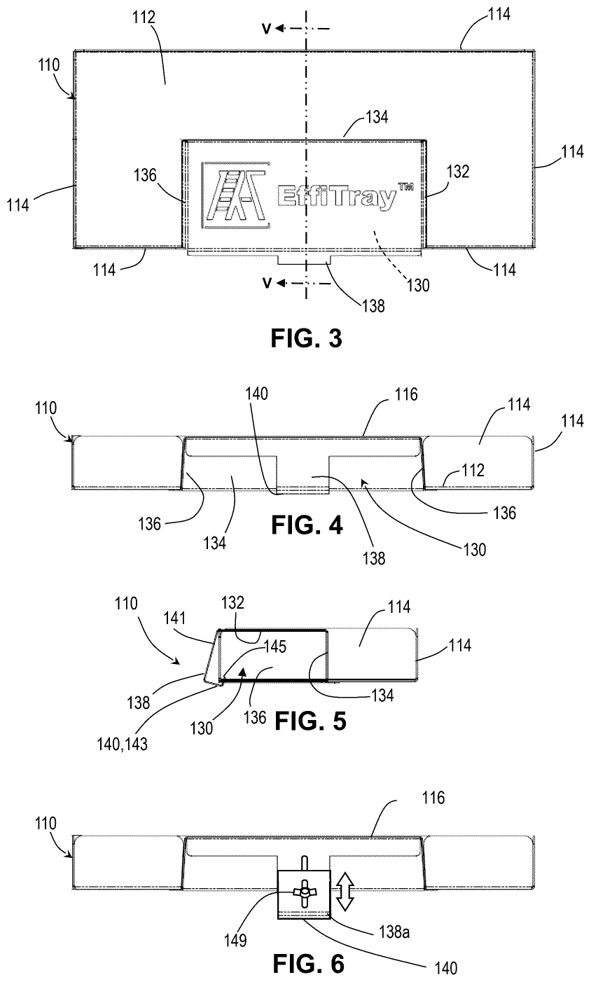

Referring collectively to FIGS. 1 to 6, there is shown a first embodiment of a tool tray 110. The tool tray 110 includes a tray bottom wall 112 and a tray peripheral wall 114 extending at least partially upwardly from the peripheral edges of the tray bottom wall 112, and surrounding the tray bottom wall 112. The tray bottom wall 112 defines a bottom wall recess 113 extending laterally inwardly thereinto. For example, the tray bottom wall 112 is shape generally like a rectangle from which a portion has been removed. Typically, the tray peripheral wall 114 is formed of a plurality of substantially rectilinear wall segments, or plates, but in some embodiments, part of the tray peripheral wall may be curved.

A recess top wall 116 extends from the tray peripheral wall 114 above the bottom wall recess 113. The tray peripheral wall 114 and the recess top wall 116 together define a step receiving recess 130 opening downwardly for receiving a step 301 of a step ladder 300, as seen in FIG. 7 for an alternative tool tray 110a. More specifically, the tray peripheral wall 114 defines recess forming segments 132, 134 and 136, which together with the recess top wall 116, are suitably sized and shaped to cover substantially the whole upper horizontal surface of the top step 301 of the stepladder 300, and at least a downward vertical portion of the lateral side surfaces thereof.

The tool tray 110a is similar tot he tool tray 110, except that the tool tray 110 further includes a plurality of keyed apertures 120 equidistantly spaced apart relative to one another, and extending transversally through at least one rectilinear wall segment of the tray peripheral wall 114. The keyed apertures 120, which may also be referred to as keyholes, may have any shape suitable for receiving a key 122 of similar shape and retaining the key 122 in the keyed aperture 120 once the former has been rotated, thereby forming a key and keyhole arrangement 121, as illustrated in FIG. 9. More specifically, the key 122 is rotatable between an unlocked orientation in which the key 122 is movable through the keyed apertures 120 and a locked orientation in which the key 122 is prevented from moving through the keyed apertures 120 through mechanical interference between the key and the tray peripheral wall 114. To that effect, the keyed aperture 120 has a non-circular shape, so that once the key 122 has been rotated after insertion through the keyed aperture 120, some portions of the key 122 protrude laterally relative the keyed aperture 120, and are therefore prevented from passing through the keyed aperture 120.

In some embodiments, the key 122 is a distinct part, which can be used to secure two trays to each other, as further described below. An example of such a key 122 is shown in FIGS. 38 to 41. The key 122 includes a key first end portion 124 insertable through the keyed aperture 120, typically substantially snugly. The key 122 also includes a key second end portion 126 that is larger than the keyed aperture 120. A key spacing portion 125, which is also insertable in the keyed aperture 120, extends between the key first and second end portions 124 and 126, so that the key first and second end portions 124 and 126 and the key spacing portion 125 extend along a key longitudinal axis 128. The key first and second end portions both protrude laterally relative to the key spacing portion 125. The key 122 is configured so that when the key first end portion 124 is inserted through the keyed aperture 120 and pushed therethrough so that the key spacing portion 125 is in the keyed aperture 120, rotating the key 122 results in the key 122 becoming locked to the keyed aperture 122 due to the key first and second end portions 124 and 126 not being able to move through the keyed aperture 120, as they now both protrude laterally relative to the keyed aperture 120, The key second end portion 126 may be shaped to act as a handle to facilitate actuation of key 122.

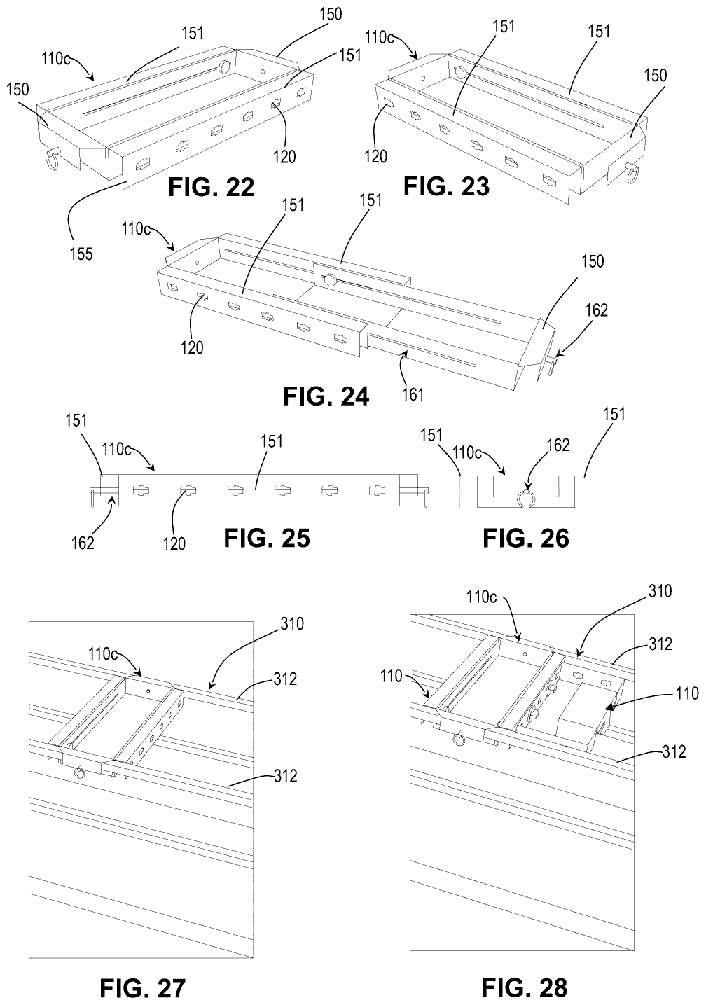

As seem for example in FIG. 21, the key 122 can be used to mount to each other two tool trays 110a and 110b that defines keyed apertures 120 that can be positioned in register with each other, so that the key 122 can be inserted through the thus aligned keyed apertures 120 of both trays 110a and 110b. These keyed apertures 120 can be defined through the tray peripheral walls 114 of both trays 110a and 110b, along portions thereof that are plate-shaped, or through a plate defining a flange 155, as seen for the tray 100c of FIG. 22.

In other embodiments, the key second end portion 126 is replaced by an accessory body 126a to 126g part of an accessory 127a to 127g securable to the tray 110a, as illustrated in FIGS. 10 to 16. For example, the accessory 127a to 127g is suitably sized and configured so as to act as one of a tool holder (for example, the accessories 127a, 127b, 127e, 127f and 127g of FIGS. 10, 11, 14, 15 and 16) or a parts container (for example the accessories 127c and 127d of FIGS. 12 and 13). Other shape configurations than the ones illustrated are also possible.

Advantageously, a user may avoid having to manually transfer tools and parts from one tool tray to another when moving from one elevated support to another by simply moving a tool tray 110, 110a or 110b from one location to another and either mounitng the tool tray to another elevated support, or to another tool tray 110a or 110b already mounted to the elevated support using one or more keys 122.

The tool tray 110 further includes a step engaging hook 138 extending downwardly from the recess top wall 116 and configured for engaging the step 301 when the step 301 is received in the step receiving recess 130. The step engaging hook 138 is typically resiliently deformable, so as to be able to snap into place when engaging the step 301 to properly secure the tool tray 110 to the stepladder 300.

Referring to FIG. 5, the step engaging hook 138 defines a hook distal end 140 opposed to the recess top wall 116. The step engaging hook 138 also defines a spacing segment 141 extending from the recess top wall 116, an intermediate segment 143 extending from the spacing segment 141 at the hook distal end 140 and an end segment 145 extending from the intermediate segment 143 opposed to the spacing segment 141, the spacing, intermediate and end segments 141, 143 and 145 together having a generally J-shaped configuration.

In some embodiments, as seen in FIG. 6, the step engaging hook 138a is length adjustable to selectively vary a distance between the recess top wall 116 and the hook distal end 140, so as to be compatible with various models and make of stepladders 300. For example, the step engaging hook 138a includes two parts that are connected to each other through a set screw and slot arrangement 149 illustrated in FIG. 6, allowing one to selectively set the length of the step engaging hook 138a by tightening a set crew, or to allow adjustment of this length by moving the slot relative to the set screw when the latter is loosened. Other known equivalent means for selectively adjusting the length dimension of the step engaging hook 138a are also possible.

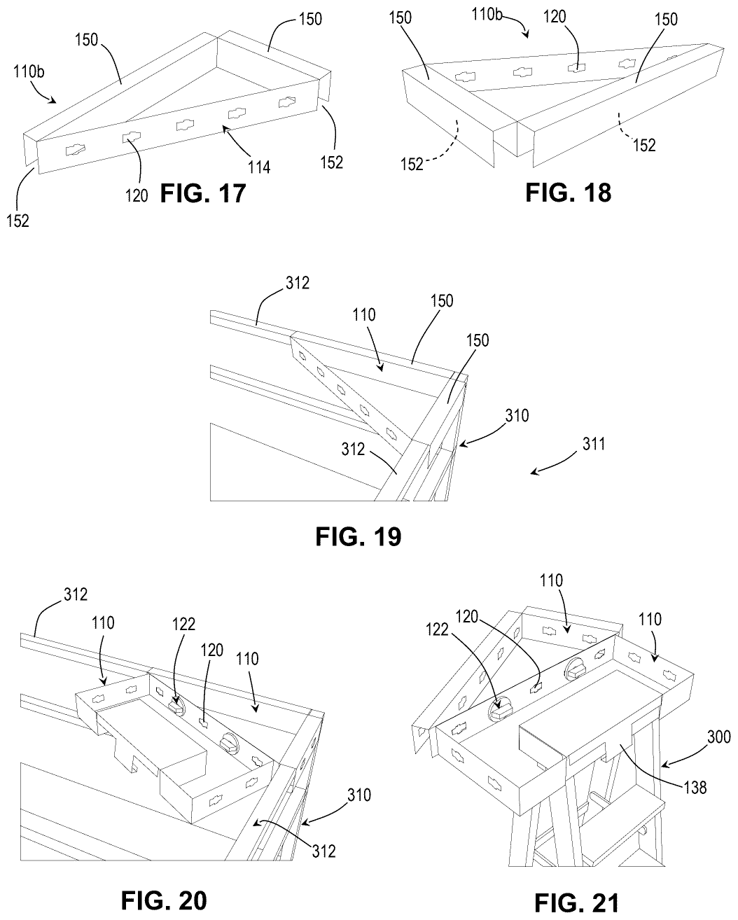

In some embodiments of the invention, as illustrated in FIGS. 17, 18, 19, 31 and 32, the tool tray 110b includes a pair of a pair of guardrail engaging hooks 150 protruding laterally outwardly relative to the tray peripheral wall 114, opening downwardly to define substantially elongated guardrail engaging hooks 152. The guardrail engaging hooks 150 are configured for engagement with a portion of two railing members 312 part of a guardrail 310, for example part of scaffolding 311 or of a nacelle, located adjacently a perpendicular junction of the latter's. More specifically, the guardrail engaging hooks 152 are suitably oriented, shaped and sized for removable parallel engagement in a saddle-like fashion on top of a respective railing member 312. For example, the tool tray 110b has a substantially right angle triangular configuration.

In yet other embodiments, as seen in the tray 110c of FIGS. 22 to 28, two longitudinally opposed guardrail engaging hooks 150 are provided, so as to engage parallel and spaced apart railing members 312. In some embodiments, as best illustrated in FIG. 24, the elongated rectangular tool tray 110c includes a user selectively adjustable telescopic arrangement 161 for allowing the tool tray 110 to be compatible with guardrails that are spaced apart by various distances having various width dimensions. The tool tray 110c thus form a drawer.

In some embodiments, the tool tray 110c further includes attachment hooks 151 shaped similarly to the guardrail engaging hooks 150, but extending perpendicular thereto. The attachment hooks include a plate 152 facing outwardly relative to the tool tray 110c that defines keyed apertures 120, allowing one to attach another tray 110a thereto, as seen in FIG. 35 for example.

In some embodiments of the invention, as best illustrated in FIGS. 22, 25 and 27, the tool tray 110c includes a user selectively removable lock pin 162 for securing each guardrail engaging hook 150 with the respective railing member 312 on which the guardrail engaging hook 150 is engaged in a saddle-like fashion.

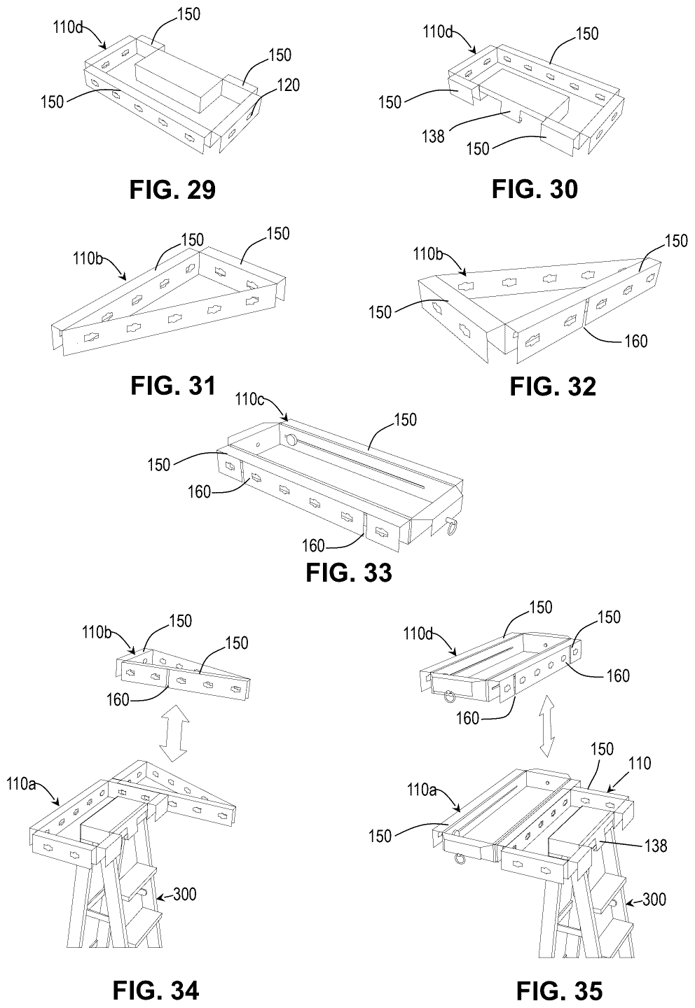

Referring to FIGS. 29, 30 and 34 to 37, in some embodiments, the tool tray 110d is similar to the tool tray 110, except that it defines guardrail engaging hooks 150 on all sides thereof. Some or all of these guardrail engaging hooks 150 may define keyed apertures 120. Typically, the keyed apertures 120 of all tool trays 110 to 110d usable together have keyhole apertures 120 that are distanced from each other by the same distance, so that thase tool trays 110 to 110d are all compatible for attachment to each other. Two of these guardrail engaging hooks 150 are provided on one of the sides of the tool tray 110d and spaced apart from each other with the step engaging hook 138 therebetween. In such embodiments, the step engaging hook 138 is resiliently deformable between an unbiased configuration and a biased configuration, as seen respectively for the top and middle tool trays 110d in FIG. 42. In the unbiased configuration, the step engaging hook 138 protrudes laterally relative to the tray peripheral wall 114. In the biased configuration, the step engaging hook 138 is moved inwardly towards the step receiving recess 136 relative to the unbiased configuration.

The guardrail engaging hooks 150 of the tool tray 110d may be slightly narrower than the guardrail engaging hooks 150 of other tool trays usable therewith, such as tool tray 110c, so that the guardrail engaging hooks 150 of the tool tray 110d can receive into the guardrail engaging hooks 150 of the tool tray 110c, as seen in FIG. 37, to facilitate coupling of these two tool trays 110d and 110c to each other, with the use of the key 122.

Referring to FIGS. 32, 33, 34 and 35, still furthermore, the outer wall of the guardrail engaging hooks 150 of some of the tool trays 110a to 110d may define one or more open slots 160 extending from a lower edge thereof and extending upwardly the whole vertical dimension of the respective guardrail engaging hook 150. Each open slot 160 is suitably sized, shaped and located along the guardrail engaging hooks 150 so as to allow a downward engagement in a saddle-like fashion, including their respective corner edge, of a selected one of the rectilinear wall segment of the tool tray 110c engageable on top of a stepladder 300.

Thus, advantageously, the tool trays 110b and 110c suitable for engagement on scaffold and nacelle railing members 302, may be user selectively and rapidly engaged and supported along a rectilinear wall segment of the tool tray 110a or 110d supported on a stepladder 300, without the use of keys 122. Obviously, the same tool trays 110b and 110c may be just as quickly removed from the one engaged on the stepladder and returned for support each on their respective scaffold or nacelle railing members. Hence, advantageously, significant time savings are achieved. Keys 122 may be used to further secure pairs tool trays in a similar manner as described further above.

Inversely, the tool tray 110 configured for engagement and support on top of a stepladder 300 may be removed therefrom and engaged and supported in a similar manner along a rectilinear wall segment of any one of the other tools trays configured for engagement on railing members using only one key 122.

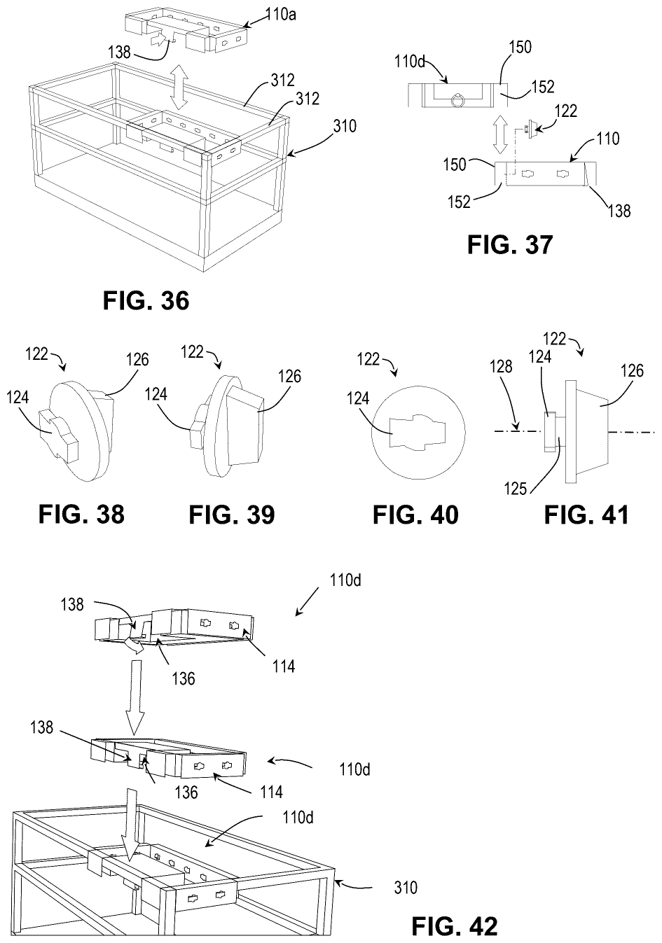

Further advantageously, the step engaging hook 138 of the tool tray 110 configured for engagement on the top of a stepladder 300 has a double function as a spring biased securing arrangement with a railing member 312. This function is accomplished when the step engaging hook 138 is at least slightly bent inward relative to the tool tray cavity 130, so as to allow the guardrail engaging hooks 150 along the rearward edge of the tool tray 110, to be engaged in a saddle-like fashion on adjacent railing member portions on each side of a perpendicular junction thereof, as illustrated in FIG. 36.

The various elements of the interlocking modular tool tray system of the present invention may manufactured using any sufficiently rigid material or materials including non limitatively plastic, aluminum, a light metal alloy, steel, etc. or a combination thereof, using well known manufacturing process's used in the manufacturing on similar tool accessories for home use, as well as in industrial contexts.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A tool tray securable to a step of stepladders and a guardrail of scaffolds and nacelles, the tool tray comprising:
a tray bottom wall defining a bottom wall recess extending laterally inwardly thereinto;
a tray peripheral wall extending upwardly from the tray bottom wall;
a recess top wall extending from the tray peripheral wall above the bottom wall recess, the tray peripheral wall and the recess top wall together defining a step receiving recess opening downwardly and configured for receiving the step;
a step engaging hook extending downwardly from the recess top wall and configured for engaging the step when the step is received in the step receiving recess; and
a pair of guardrail engaging hooks opening downwardly, protruding laterally outwardly relative to the tray peripheral wall and configured for engaging the guardrail, the step engaging hook being provided between the guardrail engaging hooks;
the step engaging hook being resiliently deformable between an unbiased configuration and a biased configuration, wherein, in the unbiased configuration, the step engaging hook protrudes laterally relative to the tray peripheral wall, and, in the biased configuration, the step engaging hook is moved inwardly towards the step receiving recess relative to the unbiased configuration.

2. The tool tray as defined in claim 1, wherein the step engaging hook defines a hook distal end opposed to the recess top wall, the step engaging hook being length adjustable to selectively vary a distance between the recess top wall and the hook distal end.

3. The tool tray as defined in claim 2, wherein the step engaging hook defines a spacing segment extending from the recess top wall, an intermediate segment extending from the spacing segment at the hook distal end and an end segment extending from the intermediate segment opposed to the spacing segment, the spacing, intermediate and end segments together having a generally J-shaped configuration.

4. The tool tray as defined in claim 1, further comprising an accessory removably mounted to the tray peripheral wall, wherein the accessory and the tray peripheral wall are mounted to each other through a key-and-keyhole arrangement including a key and a keyhole, wherein the key is rotatable between an unlocked orientation in which the key is movable through the keyhole and a locked orientation in which the key is prevented from moving through the keyhole through mechanical interference between the key and the tray peripheral wall.

5. The tool tray as defined in claim 4, wherein the keyhole includes a tray keyhole extending through the tray peripheral wall and wherein the accessory includes an accessory body and the key extending from the accessory body.

6. The tool tray as defined in claim 4, wherein the accessory includes a plate positionable parallel to a portion of the tray peripheral wall, the plate and tray peripheral wall each defining a respective keyhole configured and positioned so that the keyholes of the plate and tray peripheral wall are in register with each other when the tool tray and accessory are secured to each other, the key being inserted through both the keyholes of the plate and tray peripheral wall when the tray and the accessory are mounted to each other.

7. The tool tray as defined in claim 6, wherein the plate is peripheral to an accessory recess opening downwardly and configured for receiving thereinto the guardrail receiving hooks with the plate and tray peripheral wall adjacent and parallel to each other.

8. The tool tray as defined in claim 7, wherein the peripheral wall defines a corner at one end of the portion of the tray peripheral wall and the plate includes at least one slit for receiving the tray peripheral wall thereinto at the corner when the guardrail receiving hooks are received in the accessory recess.

9. The tool tray as defined in claim 4, wherein the accessory is an other tray.

10. The tool tray as defined in claim 9, wherein the other tray is triangular and defines perpendicularly extending other tray guardrail engaging hooks opening downwardly and configured for engaging the guardrail at a corner thereof.

11. The tool tray as defined in claim 4, wherein the accessory is a tool holder.

12. The tool tray as defined in claim 4, wherein the accessory is a drawer.

13. The tool tray as defined in claim 4, wherein the key includes a key first end portion insertable through the keyhole, a key second end portion that is larger than the keyed aperture and a key spacing portion extending between the key first and second end portions so that the key first and second end portions and the key spacing portion extend along a key longitudinal axis, the key spacing portion being also insertable in the keyhole, the key first and second end portions both protruding laterally relative to the key spacing portion.

14. The tool tray as defined in claim 13, wherein the key is configured so that when the key first end portion is inserted through the keyhole and pushed therethrough to position the key spacing portion in the keyhole, rotating the key results in the key becoming locked to the keyhole due to the key first and second end portions both protruding laterally relative to the keyhole.

15. The tool tray as defined in claim 13, wherein the key second end portion is shaped to act as a handle.
